(19) United States
(12) Patent Application Publication
(10) Pub. No.: US 2013/0346915 A1
(43) Pub. Date: Dec. 26, 2013

(54) WRAP-AROUND NAVIGATION

(71) Applicants: Holger Kuehnle, Seattle, WA (US); Raymond Chen, Redmond, WA (US); Rebecca Deutsch, Seattle, WA (US)

(72) Inventors: Holger Kuehnle, Seattle, WA (US); Raymond Chen, Redmond, WA (US); Rebecca Deutsch, Seattle, WA (US)

(73) Assignee: MICROSOFT CORPORATION, Redmond, WA (US)

(21) Appl. No.: 13/530,625

(22) Filed: Jun. 22, 2012

(51) Int. Cl. G06F 3/048

(52) U.S. Cl. 715/799

(57) ABSTRACT

Embodiments relate to enabling wrap-around of a pannable surface to allow a user to perceive a logical break and to allow some user control over how/when a wrap-around occurs. When a user pans to an edge of a pannable surface (“near” edge), the panning, in some embodiments, is automatically halted or impeded. The user can over-pan the “near” edge, and if a condition is met, then the “distant” edge pans into view, thus effectuating a wrap-around. The condition may be, for example, a threshold distance, speed, inertia, etc. Some embodiments provide a hint or visual “peek” of the “distant” edge as the “near” edge is being over-panned. Some embodiments snap the “near” edge back if the over-pan is ended before the condition is met. The condition may be checked repeatedly during over-panning or it may be checked when the over-pan is terminated by the user.

### BACKGROUND

In the field of computing, there have been many approaches to allow navigation of content in a window or view area. Scrolling windows, pannable surfaces, carousels, and other user interfaces have all been used to allow a user to control what part of a content area is displayed in a window. With a long content area, for example, it can take significant time for a user to manually pan back and forth between the beginning and end of the content area. This begin-to-end panning time can be particularly troublesome with touch-based input control. Furthermore, when an item of content needs to be rearranged in the content area, dragging the item between the beginning and the end can take notable effort and time. For instance, a user might be required to hold the item at the edge of a screen and wait for an auto-scroll operation to pan or scroll the content area to the beginning or end.

Problems of content traversal can also occur with the Start or Home screen of an application-launching interface, where newly installed application tiles or icons are placed at the end of a grid (content area) and a user wishes to navigate to the most recently added applications or move those applications to the beginning of the grid where tiles or icons of favorite applications are often accessed.

Some previous approaches have involved cycling around automatically between the beginning and the end of a content area in a continuous carousel-like fashion. However, this approach can create other problems. For example, a user cannot easily stop at the beginning or end, and the content area can be perceived as overwhelming and infinite. Moreover, the user may have difficult knowing what is the beginning or end or whether an area of content has already been seen.

Techniques related to wrap-around content navigation are discussed below.

### SUMMARY

The following summary is included only to introduce some concepts discussed in the Detailed Description below. This summary is not comprehensive and is not intended to delineate the scope of the claimed subject matter, which is set forth by the claims presented at the end.

Several of the embodiments discussed below relate to a form of circular panning. To convey the boundaries of a pannable surface, responsive to reaching an edge or boundary of the surface, panning is inhibited, thus allowing the user to perceive that they have panned to an edge. Subsequently, the surface can be over-panned, that is, the reached edge can be panned such that the edge itself is displayed in the view area. If a wrap-around condition is met, an automated wrap-around occurs. Automated wrap-around may involve automatically panning the reached edge out of the view and/or automatically panning the distant edge into the view area, thus giving an appearance of one edge panning out of view as the opposite edge pans into view. If both edges are displayed together in the view during an over-pan, the logical remoteness or break between the edges can be emphasized with visual effects such as having the entering edge pan more slowly than the exiting edge. In one embodiment, over-panning is implemented using a threshold condition. When the threshold condition is met, auto-wrap occurs. When over-panning ends and the threshold is not met, the over-panning is reversed (e.g., a preview of the distant edge disappears and/or the over-panned edge snaps into view). It will be appreciated that implementation details will vary in carrying out the above-described embodiments.

Many of the attendant features will be explained below with reference to the following detailed description considered in connection with the accompanying drawings.

### BRIEF DESCRIPTION OF THE DRAWINGS

The present description will be better understood from the following detailed description read in light of the accompanying drawings, wherein like reference numerals are used to designate like parts in the accompanying description.

FIG. 1 shows a panning user interface.

FIG. 2 shows an overview of a process for wrap-around panning.

FIG. 3 shows a wrap-around panning embodiment where panning by default is hard-stopped and where a user can override the hard stop by then “over-panning”.

FIG. 4 shows another embodiment for wrap-around panning navigation.

FIG. 5 shows an example of a visual effect that may be used to indicate over-panning.

FIG. 6 shows a process for automated wrap-around panning corresponding to FIG. 5.

FIG. 7 shows yet another embodiment of wrap-around panning.

FIG. 8 shows a computing device.

### DETAILED DESCRIPTION

Embodiments described below relate to wrap-around content navigation. Some embodiments may allow for beginning-to-end wrap-around navigation while avoiding inconveniences of previous techniques. The discussion below will begin with an overview of content navigation, followed by detailed description of wrap-around navigation embodiments, including an embodiment where a user may encounter various forms of a “hard” stop when panning up to a beginning or end, but can invoke a wrap-around operation when a pan starts with a beginning or end at or near the hard stop position. With another embodiment, a user determines whether a wrap-around occurs based on the nature of the user input; e.g., if a user-controlled pan ends with (or attains) sufficient inertia a wrap-around occurs. Other embodiments and variations are also described below.

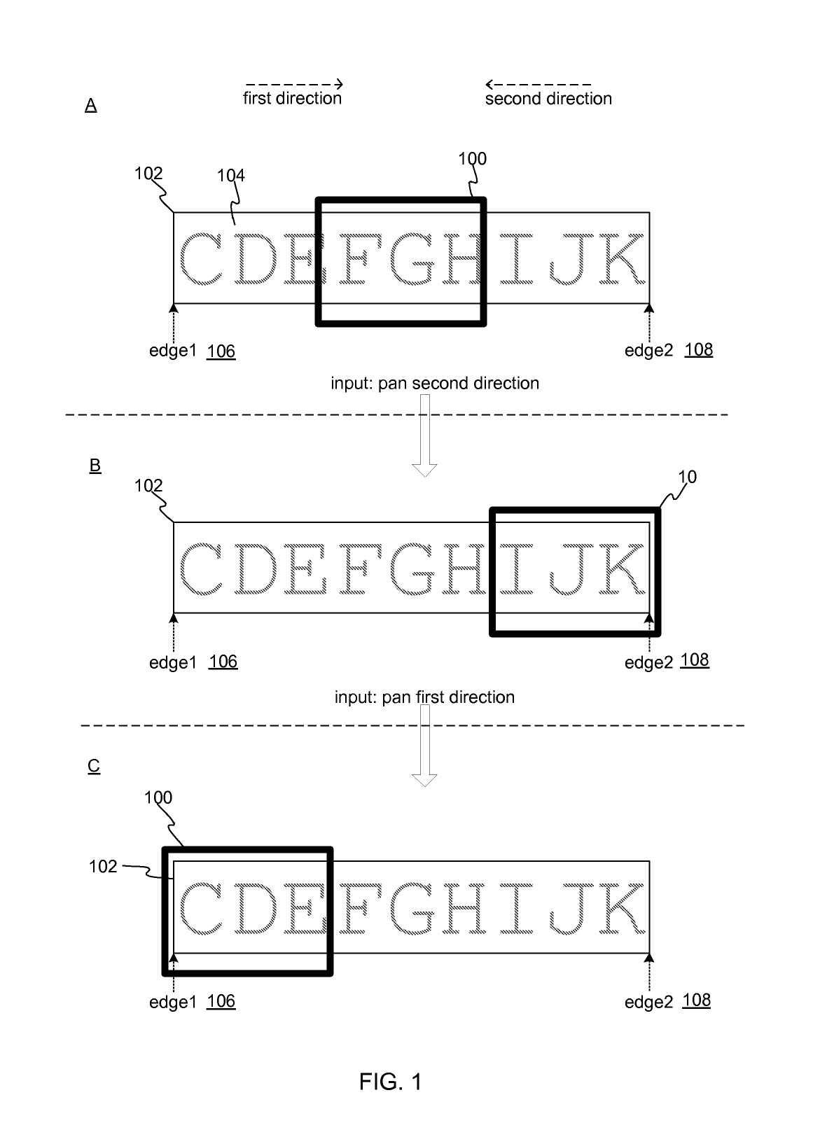

FIG. 1 shows a panning user interface. As shown in Frame A, the user interface has a view area 100, and a surface 102 containing content 104. The surface 102 has edges—edge1 106 and edge2 108, that may also be referred to herein as a beginning and an end or as a lead edge and tail edge. The surface 102 may be larger than the view area 100, and a user may pan the surface 102 to see different portions of the content 104. Panning may involve displaying a smooth or continuous movement of the surface 102 through the view area 100. There are nearly a limitless number of ways that a user can initiate, control, and terminate a pan of the surface 102. Consider the following examples. A user may drag the surface 102 with a stroke inputted with an input device. The input device might be a mouse, a two-dimensional gesture detection system (e.g., a touch surface), a three-dimensional gesture detection system (e.g., Kinect (™), by Microsoft Corp.), or others. Termination of the stroke may cause the surface 102 to glide to a stop or stop abruptly. A user may continuously activate/deactivate a pan by holding/releasing a physical button, maintaining/ceasing a touch gesture, activating/deactivating a user-interface button, holding/changing a 3D gesture, and so forth.

The panning action of the surface 102 may appear to be smooth or continuous (with perhaps some minimal movement delta). The panning action may also vary at the end of a pan. For example, when a pan is ending, the surface 102 may automatically snap to a nearest point such as a marker, a page division, a content feature, etc. Or, the surface 102 may stop abruptly, “bounce” slightly, or gradually glide to a rest. In some cases, the surface 102 may be panned to any arbitrary point of content 104, while in other cases panning stop points may be restricted. In some embodiments, panning may vary in speed according to user input, according to content features or markers that are panned into view, etc.

While examples described herein may show rectangular windows and view areas with rectangular panning surfaces panning from left to right, embodiments described herein may be implemented with different window and surface shapes and with different panning directions. For example, the concepts and embodiments described herein may be used when panning or scrolling horizontally, or even when a surface is larger in all directions than the view area and the surface can be panned in arbitrary directions.

Returning to FIG. 1, a default panning behavior will be described. In frame A of FIG. 1, a user is able to pan the surface 102 in either a first direction (a direction from edge1 106 to edge2 108), or in a second direction (a direction from edge2 108 to edge1 106). When there is user input that indicates a pan in the second direction, as shown in Frame B, edge2 108 moves toward the view area 100. When edge2 108 reaches (is near, touches, or enters) the view area 100, the default pan behavior is to automatically stop the panning. A bounce or other visual indication may be used to show that an edge of the surface 102 has been reached. Frame C shows the position of the surface after panning in the first direction. When a user provides input to pan in the second direction the surface 102 similarly moves to and stops at the view area 100.

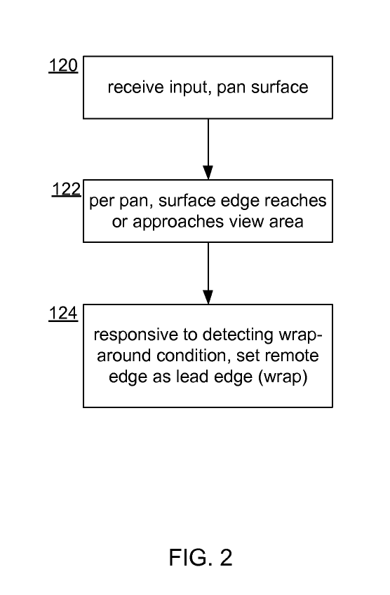

FIG. 2 shows an overview of a process for wrap-around panning. At step 120, an input is received to pan the surface 102. At step 122, the pan (e.g., in the first direction) causes a stop edge (e.g., edge1 106) of the surface 102 to reach or approach the view area 100. At step 124, after step 122, a wrap-around condition is detected and in response a remote edge (e.g., edge2 108) is set as a lead edge of the surface 102. That is, the remote edge automatically pans into the view area 100 and the stop edge automatically pans out of the view area 100. As will be described below, the wrap-around condition can vary and can be used in different embodiments.

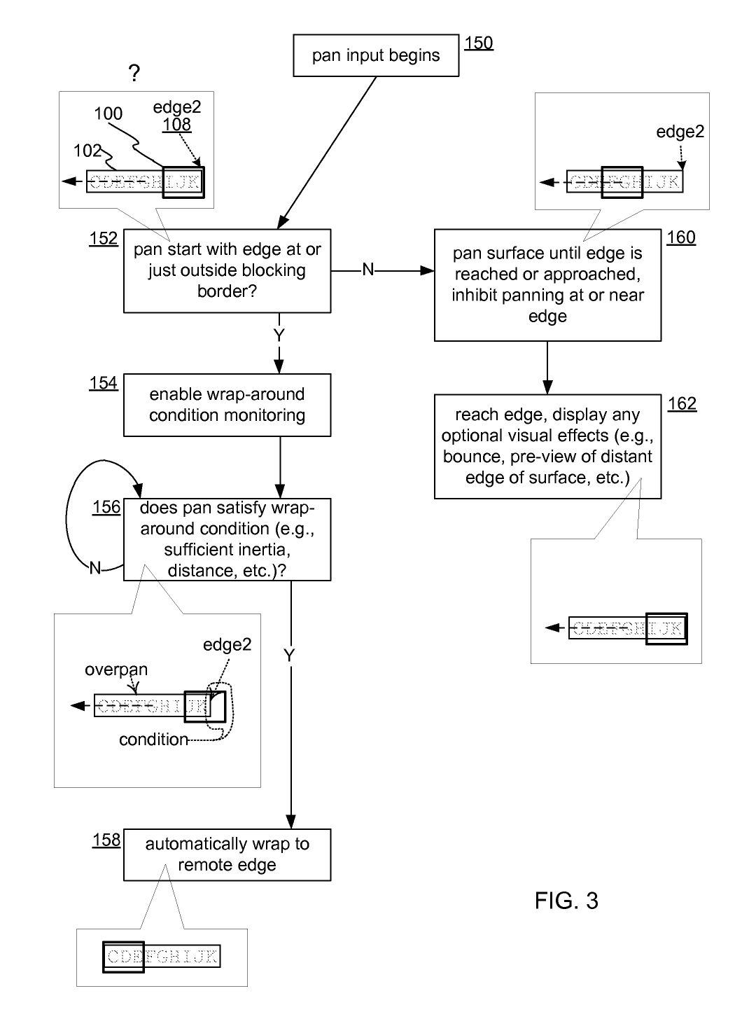

FIG. 3 shows a wrap-around panning embodiment where panning by default is hard-stopped when an edge is panned to the view area and where a user can override the hard stop by then “over-panning” the surface 102. At step 150, a pan input to the left, for example, is started. At step 152, it is determined whether the pan is starting with a surface edge (e.g., edge2 108) at or just outside a blocking border of the view area 100. That is, it is determined if the surface 102 has already panned to its beginning or end such that wrapping might be a semantic possibility. If it is determined that the surface 102 is at a hard-stop position when panning starts, step 154 enables wrap-around condition monitoring. That is, the overall panning control process begins to enable the user to override the hard-stop by providing appropriate input (for panning) that satisfies the wrap-around condition. At step 156 the panning (or input therefor) is monitored to determine if the wrap-around condition is met. At step 158, after the condition has been determined to have been satisfied, an automated wrap-around is performed such that the remote (non-stopping) edge of the surface 102 becomes available for panning at the view area 100.

Referring to steps 154 and 156, the wrap-around condition may be implemented in numerous ways. In one embodiment, the surface 102 may be slightly over-panned, that is, the user can pan the stop edge past a border of the view area 100 and into the view area 100. In the example of FIG. 3, as shown in the bubble accompanying step 156, edge2 108, the stop edge, is overpanned into the view area 100. The wrap-around condition may correspond to the speed, inertia, or position of the surface 102 during such an over-pan. When the speed, inertia, position, distance, etc., reaches a threshold, then wrap-around is automatically triggered as soon as the wrap-around condition is met. In one embodiment, the wrap-around condition is checked only when the over-pan operation ends, for instance when the user stops over-panning the surface 102 by terminating an input such as a stroke or drag. In another embodiment, the wrap-around condition is checked repeatedly and when the condition occurs (e.g., the over-pan has moved the surface with sufficient speed, distance, etc.) the wrap-around effect is automatically triggered, regardless of whether the user has discontinued over-panning the surface 102.

Referring to step 158, the wrap-around can be performed in numerous ways. The stop edge can pan across and out of the view area 100 as the wrapped-to edge comes into the view area 100. The stop edge can disappear and the surface can be abruptly repositioned to bring the remote edge to the view area 100. Or, the stop edge may pan out of the view area 100 and then the remote edge pans into the view area 100. Other visual approaches may be used to indicate that a wrap-around is occurring.

Referring again to step 152, when the panning does not start with an edge at or near the view area (i.e., no overpanning occurs), then the default panning behavior occurs; panning until an edge is reached. At step 160 the surface pans until an edge is reached or approached, and then panning is inhibited. At step 162, when the stopping edge is reached, an effect may be provided which may help the user perceive that the edge can be overpanned (wrapped). For example, the surface 102 may “bounce” in the view area 100 (possibly displaying a preview of the distant edge), the view area 100 may flash, a sound may be played, etc. Note that inhibiting panning may occur in different ways; an abrupt stop, a forced slowing of panning as the edge approaches the view area, a bouncing stop as mentioned above, and so forth.

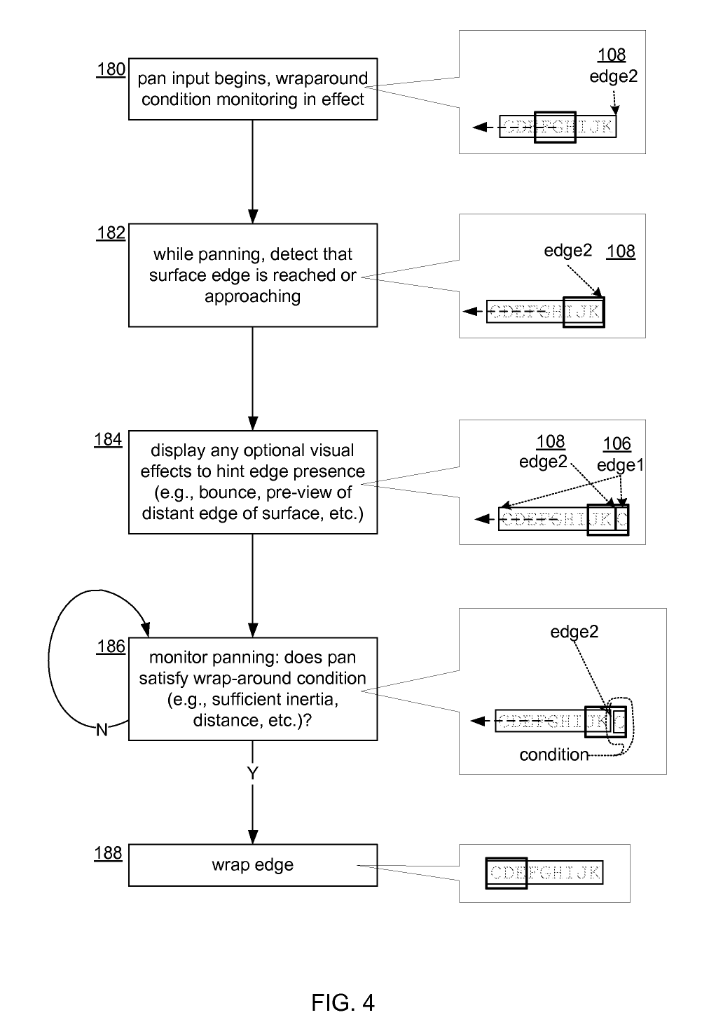

FIG. 4 shows another embodiment for wrap-around panning navigation. Generally, this embodiment may involve a pan that brings a stop edge to the view area, provides an effect to indicate that an end of the panning surface has been reached, and then provides an effect of over-panning wrapping the surface. At step 180 a pan input (leftward in FIG. 4) begins and wraparound condition monitoring is in effect. At step 182, while the panning continues the approach or arrival of a surface edge at the view area is detected. At step 184 the panning continues (e.g., the user continues to drag or pan the surface) until the surface edge reaches the view area (e.g., edge 2 108 enters or approaches the view area). At this point an effect may be displayed to indicate that an edge or end of the surface has been reached. For example, the effect may be a movement pattern of the surface; the surface may slow down substantially or even stop, despite continuing pan input from the user. As another example, a color, sound or graphic effect may be provided to indicate the beginning or end of the surface.

At step 184, as the user continues to pan (or provide input to pan) the surface, an over-pan effect is provided to indicate that the user may be able to over-pan. For example, a preview of the distant edge (e.g., edge1 106) is shown in the view area. At step 186, the panning is monitored. If a wrap-around condition is met then at step 188 the distant edge is transitioned into the view area (wrapped) and the overpanned edge is transitioned out of the view area. The wrapping may be conceptually thought of as forming a loop with the surface by feeding the remote edge back into the view area to allow continued panning. As mentioned previously, the wrap-around condition can be implemented in different ways.

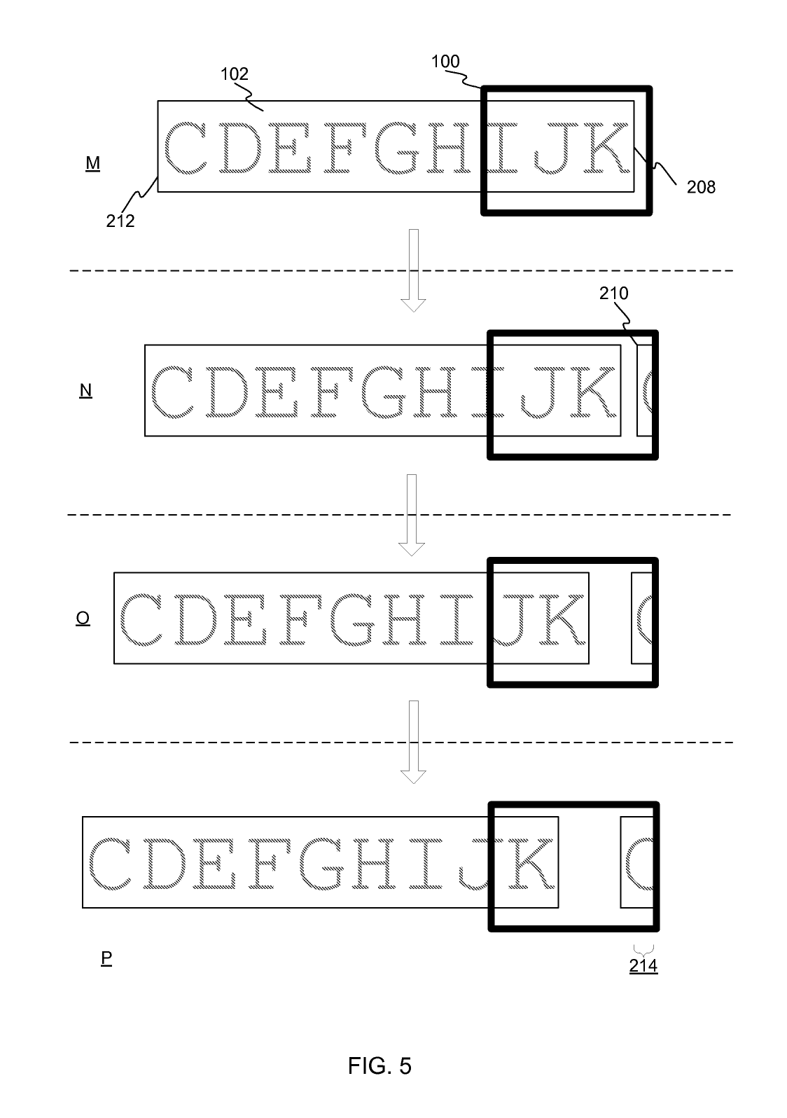

FIG. 5 shows an example of a visual effect that may be used to indicate over-panning. For a leftward pan, a sequence of display outputs is shown in chronological order starting from the top of FIG. 5. Initially, at frame M, a user has just begun to over-pan the surface 102. An end 208 of the surface 102 is at or just past its leftward panning limit in the view area 100. At frame N a preview 210 of beginning edge 210 is shown in the view area. At this point, if the panning is stopped (e.g., a stroke or drag ends) and a wrap-around condition is not met (e.g., the end 208 has not moved a threshold distance from the border of the view area 100), then the surface automatically snaps rightward until the end 208 is at the border or a margin of the view area 100.

Continuing to frame O, as the leftward panning continues, the surface and the preview 210 continue panning leftward in the view area. In one embodiment, this gap dynamically grows, possibly as soon as the preview 210 begins to be displayed. That is, the surface and the preview 210 may have different panning rates.

At frame P, as the leftward panning continues, the preview 210 stops emerging (panning leftward) after it reaches a position corresponding to a threshold distance 214 from the right border of the view area 100. The threshold distance 214 may be: a static number such as a number of pixels, a dynamic number such as a ratio of a size of the view area, a number computed according to a size of the surface and/or a size of the view area 100, a size of a grid unit of the surface, a size of an item in the surface, etc. Although the preview 210 may stop, the surface is allowed to continue over-panning leftward, creating a gap between the preview 210 and the end 208.

Subsequently, a wrap-around may be performed, for example, if the surface is panned sufficiently further by the user, if the panning is ended by the user and the surface or preview 210 have been panned a sufficient distance, or a similar condition (e.g., pan inertia) is met. This can be indicated by automatically panning the preview 210 leftward, in effect causing the beginning 212 of the surface to be at the leftward side of the view area 100 such that the surface can then be panned its full length leftward. Conversely, if a wrap-around is not triggered the surface may automatically pan such that the end 208 moves to the rightward border of the view area.

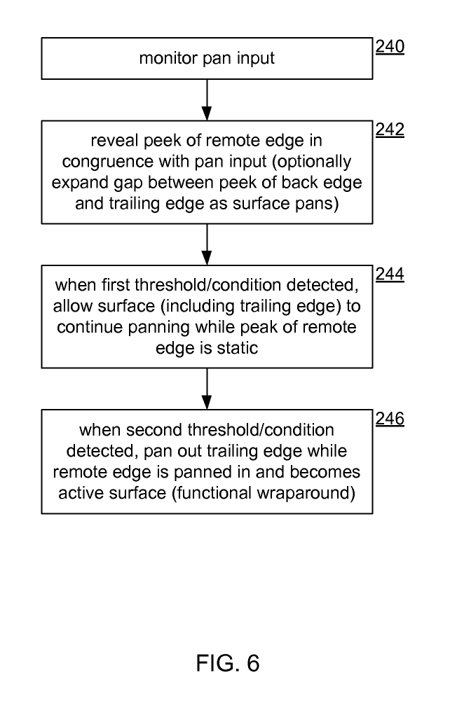

FIG. 6 shows a process for automated wrap-around panning corresponding to FIG. 5. At step 240 a pan input is monitored. At step 242, as a trailing edge over-pans (e.g., leftward), a peek or reveal of a remote edge is displayed (e.g., from a right side of the view area). Optionally, the trailing edge pans at a higher rate than the peek or preview of the remote edge. At step 244, when a first threshold is reached (e.g., the peek of the remote edge has emerged a given distance), the peek stops panning while the trailing edge continues to pan. At step 246, when a second threshold or condition is detected, auto-wrapping is invoked. The trailing edge pans out of view and the peek of the remote edge pans across the view area and becomes the currently panned-to part of the surface.

In one embodiment, the stop-point for the peek of the remote edge is the same at the point at which auto-wrapping occurs.

To facilitate displaying a preview or peek of a remote edge of the surface, it may be helpful to capture and store a bitmap or image of the remote edge. This will allow implementation using a user interface control that does not innately provide for displaying two edges of a same surface at the same time. When one edge is overpanned, the bitmap or image of the other edge is displayed. In addition, it may be desirable to disable interaction with content of the surface when over-panning, when auto-wrapping, when revealing a peek of a remote edge, etc. In one embodiment, the peek or preview that is displayed can be a mockup or generic representation of a surface edge and content. A blank surface area may also be used.

Furthermore, as previously mentioned, all of the features and embodiments described above can be readily implemented when panning is triggered by dragging an item. When the item reaches the border of the view area the surface auto-pans until the item is dropped or moved away from the border. Item dragging can also be performed when an item is selected and “held” by a user while the user simultaneously provides input to pan the surface; the surface pans for instance by stroke inputs while the item stays somewhat stationary relative to the view area.

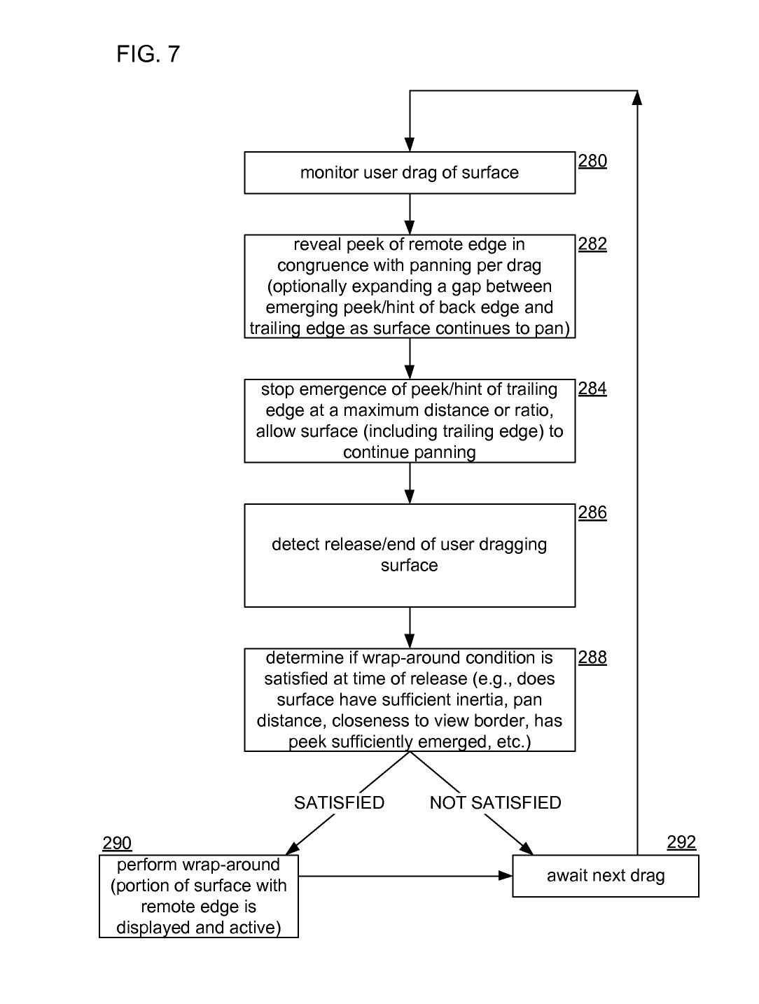

FIG. 7 shows yet another embodiment of wrap-around panning. At step 280, the computation operations involved in panning a surface (e.g., by dragging) also monitor panning to detect various over-pan and wrap-around conditions. At step 282, during the monitoring, it is determined to show a hint or peek of a surface edge that is opposite the edge at the view area. Again, the hint or peek may be an actual copy or image of the surface's opposite edge, or the peek may be some other representation of the surface. At step 284, emergence of the peek/hint stops when a first condition is met. At step 286, the panning of the surface is terminated by the user. This triggers step 288, where it is determined if a wrap-around condition is satisfied. When the condition exists, at step 290, wrap-around is performed. When the condition does not exist at the panning termination, at step 292 the process continues.

To summarize several of the embodiments discussed above, a form of circular panning may be implemented. To convey the boundaries of a pannable surface, responsive to reaching an edge or boundary of the surface, panning is inhibited, thus allowing the user to perceive that they have panned to an edge. Subsequently, the surface can be over-panned, that is, the reached edge can be panned such that the edge itself is displayed in the view area. If a wrap-around condition is met, an automated wrap-around occurs. Automated wrap-around may involve automatically panning the reached edge out of the view and/or automatically panning the distant edge into the view area, thus giving an appearance of one edge panning out of view as the opposite edge pans into view. If both edges are displayed together in the view during an over-pan, the logical remoteness or break between the edges can be emphasized with visual effects such as having the entering edge pan more slowly than the exiting edge. It will be appreciated that implementation details will vary in carrying out the above-described embodiments.

### CONCLUSION

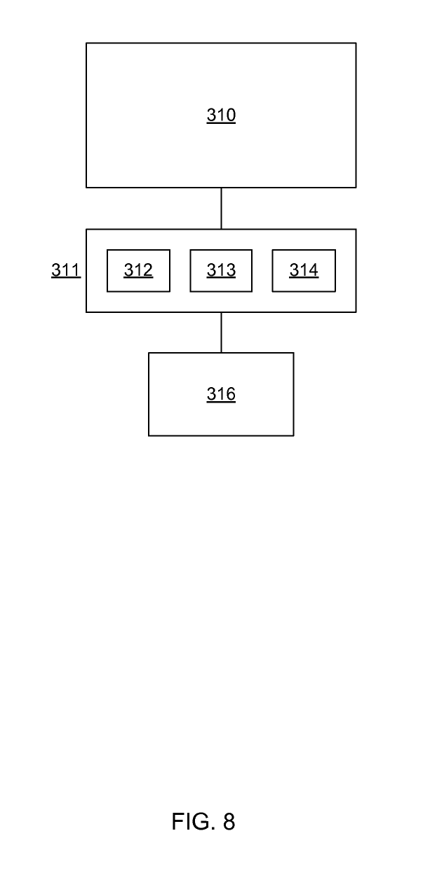

FIG. 8 shows a computing device for implementing embodiments described herein. The computing device may have a display 310, a processing component 311 including a processor 312, volatile storage (memory) 313, non-volatile storage 314, and one or more input devices 316. The input devices 316 may be a touch sensitive surface (possibly integrated with display 310), a mouse, a 3D-motion sensor (e.g., a camera), a pressure sensitive tablet surface, and so forth.

Embodiments and features discussed above can be realized in the form of information stored in the storage volatile and/or non-volatile computer or device readable media. This is deemed to include at least media such as optical storage (e.g., compact-disk read-only memory (CD-ROM)), magnetic media, flash read-only memory (ROM), or other means of physically digital information in a physical form (not to be interpreted as including energy or signals per se). The stored information can be in the form of machine executable instructions (e.g., compiled executable binary code), source code, bytecode, or any other information that can be used to enable or configure computing devices to perform the various embodiments discussed above. Again, this is also deemed to include at least volatile memory such as random-access memory (RAM) and/or virtual memory storing information such as central processing unit (CPU) instructions during execution of a program carrying out an embodiment, as well as non-volatile media storing information that allows a program or executable to be loaded and executed. The embodiments and features can be performed on any type of computing device, including portable devices, workstations, servers, mobile wireless devices, and so on.

1. A method of displaying a surface, the method comprising:
displaying the surface in a view area in which portions of the surface are displayed and panned, where the surface pans according to user input to cause the portions of the surface to be displayed and panned in the view area, the surface comprising a first edge and an opposing second edge;
when the first edge is not displayed in the view area, receiving a first user input and in response performing a first panning of the surface in a given direction relative to the view area such that the first edge is panning in the given direction toward the view area, and during the first panning automatically inhibiting the first panning when the first edge reaches the view area;
when the first edge is at the view area after the first panning was inhibited, receiving a second user input and in response performing a second panning of the surface in the given direction, and during the second panning automatically causing the surface to wrap-around such that the first edge pans out of the view area in the given direction.

2. A method according to claim 1, wherein after the causing the wrap-around the second panning causes the second edge to move in the given direction toward the view area.

3. A method according to claim 1, wherein the view area comprises a first side and an opposing second side, the first edge is opposite the second edge, the method further comprising performing the automatic inhibiting when the first edge is panned to the first side, and the causing the wrap-around comprises allowing the first edge to pan to the second side pan, during the second panning, across the view area from the first side to the side.

4. A method according to claim 1, further comprising, during the second panning, concurrently displaying both the first edge and the second edge in the view area.

5. A method according to claim 4, further comprising increasing a distance between the displayed first edge and the displayed second edge as both the first edge and second edge pan in the given direction during the second panning.

6. A method according to claim 1, wherein the inhibiting comprises preventing further panning of the surface in the given direction while the user provides input corresponding to panning in the given direction.

7. A method according to claim 6, further comprising monitoring for a wrap-around condition after the inhibiting has been performed, and when the wrap-around condition is determined to have been satisfied according to a user input, the automatic wrap-around is triggered.

8. A method according to claim 7, wherein the wrap-around condition comprises either panning the surface such that the edge reaches a threshold distance or panning rate, or a user input ends a panning of the surface when the first edge is at or beyond a threshold distance from a border of the view area.

9. One or more computer readable storage media storing information to enable a computing device to perform a process, the process comprising:
displaying a pannable surface in a display area;
receiving user input that causes panning of the pannable surface in the display area, the pannable surface having a tail edge and a lead edge, wherein the surface pans in a direction from the tail edge to the lead edge; and
during the panning, while the tail edge is in the display area, in response to a user-initiated end of the panning, causing the lead edge to automatically pan in the direction in the display area.

10. One or more computer readable storage media according to claim 9, the process further comprising wrapping the pannable surface such that the tail edge is positioned out of the display area and can be panned in the direction toward the display area.

11. One or more computer readable storage media according to claim 9, the process further comprising determining, when the user-initiated end of the panning occurs, whether a distance that is determined by the panning of the pannable surface satisfies a threshold distance, and when so determined, causing the tail edge to pan in the direction in the display area while the lead edge pans out of the display area.

12. One or more computer readable storage media according to claim 11, wherein the distance comprises a distance between a part of the surface and a border of the display area, or the distance corresponds to a distance of the tail edge from an edge of the display area.

13. One or more computer readable storage media according to claim 9, wherein the display area comprises a plurality of user-selectable content items, and the user input that causes the panning, or another input, causes movement, relative to the pannable surface, of a user-selected content item.

14. A method of panning performed by a device comprising a processor and a display, the method comprising:
displaying a view area having a first side and an opposing second side;
displaying a pannable area within the view area, the pannable area having a beginning and an opposing end, where a distance between the beginning and the end is greater than a distance between the first side and the second side, the pannable area having a default panning behavior of allowing a user to:
pan the pannable area in a first direction that is from the first side toward the second side such that the beginning cannot be panned more than a given distance past the first side, the distance being zero or more, and
pan the pannable area in a second direction that is from the second side toward the first side such that the end cannot be panned more than the given distance past the second side; and
allowing the user to pan the pannable area such that the default panning behavior is overridden where: the beginning pans past the first side as the end pans into the view area, or the end pans past the second side as the beginning pans into the view area.

15. A method according to claim 14, further comprising, during panning of the pannable area, repeatedly evaluating a condition that depends on the panning of the pannable area, and when the condition is determined to be met the default panning behavior is overridden.

16. A method according to claim 14, wherein the user pan that overrides the default behavior comprises a move operation that moves an item of content in the pannable area.

17. A method according to claim 14, further comprising panning the pannable area in the first direction, determining whether the condition is met, wherein when the condition is determined to be met the end of the pannable area is automatically panned in view area in the first direction to the second side.

18. A method according to claim 17, wherein when the condition is determined to not be met the beginning is automatically panned in the view area in the second direction to the first side.

19. A method according to claim 18, wherein the determining whether the condition is met is performed responsive to a user input that controls the panning in the first direction, and wherein the condition corresponds to a distance between the first side and the beginning.

20. A method according to claim 14, further comprising:
concurrently displaying a preview of the end at the first side as the user pans the beginning in the view area in the first direction;
while so displaying the beginning and the preview of the end, determining according to a distance of a part of the pannable area relative to the view area whether a condition is met;
when the condition is not met automatically snapping the beginning in the second direction to the first side; and
when the condition is met automatically snapping the preview of the end in the first direction to the second side.
